(19) United States
(12) Patent Application Publication
(10) Pub. No.: US 2023/0416498 A1
(43) Pub. Date: Dec. 28, 2023

(54) Polyaminosiloxane Water Tree Repellant for Electrical Insulation

(71) Applicant: Dow Global Technologies LLC, Midland, MI (US)

(72) Inventors: Chao He, Shanghai (CN); Yabin Sun, Shanghai (CN); Qian Gou, Phoenixville, PA (US); Jeffrey M. Cogen, Flemington, NJ (US); Timothy J. Person, Pottstown, PA (US)

(21) Appl. No.: 18/251,271

(22) PCT Filed: Oct. 29, 2020
(86) PCT No.: PCT/CN2020/124807

§ 371 Date: May 1, 2023

(51) Int. Cl. C08K 5/544; H01B 3/44

(52) U.S. Cl. CPC C08K 5/544; H01B 3/441

(57) ABSTRACT

A crosslinkable composition including an ethylene-based polymer, an aminosilane, and optionally a peroxide. The aminosilane is represented by the following formula (I): wherein R₁, R₂, and R₃ are the same or different and individually selected from the group consisting of hydrogen and a C₁-C₂₀ alkyl group; Y₁ is selected from the group consisting of an alkyl group and an alkoxy group; Y₂ is selected from the group consisting of an alkyl group and an aminoalkyl group, and n is 0 or 1. A crosslinked composition formed from the crosslinkable composition is also disclosed.

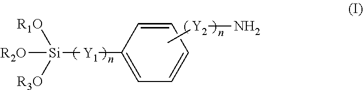

### BACKGROUND

Known is cross-linked ethylene polymer (XLPE) for the insulation of electrical wire and cable. As an insulator, XLPE, provides various physical and electrical properties, such as resistance to mechanical cut through, stress crack resistance and dielectric failure.

XLPE insulation in medium voltage (MV, 5-69 kV) cable and high voltage (HV, 70-225 kV) cable and extra high voltage (EHV,>225 kV) cable, in particular, are susceptible to the phenomena of treeing. The term “treeing” is a deterioration of the electrical insulation material that has the appearance of a tree-like path through the insulation material, the XLPE. Treeing is problematic as it is an electrical breakdown of the XLPE insulation. “Water trees” develop from water, voids, contaminants and/or defects present within the insulation material under alternating electric field. Water trees grow in the direction of the electrical field and emanate from imperfections which have the effect of increasing the electrical stress at local sites. The branches of water trees are narrow, on the order of 0.05 microns. Water trees increase in length with time, frequency and increasing voltage. Water trees are detrimental because they are electrically conductive and reduce the insulative capacity of the insulation layer, which can eventually cause cable break down.

“Electrical trees” are the result of internal electrical discharges that decompose the insulation material. Electrical trees emanate from localized heating, thermal decomposition, mechanical damage due to electrical stress, small voids, and/or air inclusions around contaminants.

The art recognizes the need for wire and cable insulation material resistant to treeing. Further recognized is the need for XPLE insulation material resistant to treeing, the XLPE having low dissipation factor, while maintaining suitable crosslink-ability to maintain mechanical strength, crack resistance, and dielectric failure.

### SUMMARY

The present disclosure provides a composition. In an embodiment, the composition is a crosslinkable composition and includes an ethylene-based polymer, an aminosilane, and optionally a peroxide. The aminosilane has the Formula (I)

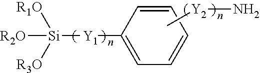

wherein
R₁, R₂, and R₃ are the same or different and each individually is selected from the group consisting of hydrogen and a C₁-C₂₀ alkyl group,
Y₁ is selected from the group consisting of an alkyl group and an alkoxy group,
Y₂ is selected from the group consisting of an alkyl group and an aminoalkyl group, and
n is 0 or 1.

The present disclosure provides another composition. In an embodiment, a crosslinked composition is provided and includes an ethylene-based polymer, and an aminosilane. The aminosilane has the Formula (I)

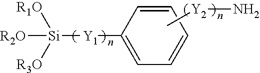

wherein
R₁, R₂, and R₃ are the same or different and each individually is selected from the group consisting of hydrogen and a C₁-C₂₀ alkyl group,
Y₁ is selected from the group consisting of an alkyl group and an alkoxy group,
Y₂ is selected from the group consisting of an alkyl group and an aminoalkyl group, and
n is 0 or 1.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

An “alkyl group” is a saturated linear, cyclic, or branched hydrocarbonyl group. Nonlimiting examples of suitable alkyl groups include methyl, ethyl, n-propyl, i-propyl, n-butyl, t-butyl, i-butyl (or 2-methylpropyl), etc.

An “aminoalkyl group” is an alkyl group containing one or more amino groups.

An “amino group,” is a nitrogen atom attached by a single bond to a hydrogen atom and/or to a hydrocarbon.

An “aminosilane,” is a silane containing one or more primary and/or secondary amino groups.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” is a polymer that contains more than 50 weight percent (wt %) polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably.

The term “ethylene monomer,” or “ethylene,” as used herein, refers to a chemical unit having two carbon atoms with a double bond there between, and each carbon bonded to two hydrogen atoms, wherein the chemical unit polymerizes with other such chemical units to form an ethylene-based polymer composition.

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure.

The term “linear low density polyethylene,” (or “LLDPE”) as used herein, refers to a linear ethylene/α-olefin copolymer containing heterogeneous short-chain branching distribution comprising units derived from ethylene and units derived from at least one C₃-C₁₀ α-olefin, or C₄-C₈ α-olefin comonomer. LLDPE is characterized by little, if any, long chain branching, in contrast to conventional LDPE. LLDPE has a density from 0.910 g/cc to less than 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

The term “low density polyethylene,” (or LDPE) as used herein, refers to a polyethylene having a density from 0.910 g/cc to less than 0.940 g/cc, or from 0.918 g/cc to 0.930 g/cc, and long chain branches with a broad molecular weight distribution (MWD)—i.e., “broad MWD” from 4.0 to 20.0.

An “olefin” is an unsaturated, aliphatic hydrocarbon having a carbon-carbon double bond.

The term “phenyl” (or “phenyl group”) is a C₆H₅ aromatic hydrocarbon ring having a valence (typically univalent).

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “silane,” as used herein, is a compound with one or more Si—C bonds.

### TEST METHODS

Density is measured in accordance with ASTM D792, Method B. Results are reported in grams per cubic centimeter (g/cc).

Dielectric Constant and Dissipation Factor Tests are conducted in accordance with ASTM D150-11, Standard Test Methods for AC Loss Characteristics and Permittivity (Dielectric Constant) of Solid Electrical Insulation, at 50 Hz on a High Precision High Voltage Capacitance Bridge, QS87 from Shanghai Young Electrical Co. Ltd. with an electrode containing specimen holder in an oven, the high voltage power was YG8Q from Shanghai Young Electrical Co. Ltd. The test specimen is a cured (crosslinked) compression molded plaque prepared by Crosslinked Polyolefin Product and Compression Molded Plaque Preparation Method 1. Degas the plaque in a vacuum oven at 70° C. for 24 hours under atmospheric pressure. Trim test specimen, test thickness, and then sandwich between two electrodes in an oven at 110° C. immediately after the electrode temperature reaches 100° C. Set potential at 2.5 kilovolts (kV), 5 kV, 7.5 kV, 11 kV, 7.5 kV, 5 kV, and 2.5 kV (all at 50 Hertz) across the film; calculate electrical stress on the film as equal to the applied voltage across the film divided by the thickness of the film in millimeters (mm); and test dissipation factor (“DF”) and relative permittivity (i.e., dielectric constant, εᵣ). Obtain a dissipation factor (DF) curve at different electrical stress values, typically plotted over a range from 5 kV/mm to 30 kV/mm. From the curve, calculate the DF value for electrical stress equal to 25 kV/mm.

Melt Index

The term “melt index,” or “MI” as used herein, refers to the measure of how easily a thermoplastic polymer flows when in a melted state. Melt index, or I₂, is measured in accordance by ASTM D 1238, Condition 190° C./2.16 kg, and is reported in grams eluted per 10 minutes (g/10 min). The 110 is measured in accordance with ASTM D 1238, Condition 190° C./10 kg, and is reported in grams eluted per 10 minutes (g/10 min).

Moving Die Rheometer (MDR) Test

MDR test was conducted on MDR2000 (Alpha Technologies) at 180° C. for 20 minutes while monitoring change in torque according to ASTM D5289-12, Standard Test Method for Rubber Property—Vulcanization Using Rotorless Cure Meters. Designate the lowest measured torque value as “ML”, expressed in deciNewton-meter (dN-m). As curing or crosslinking progresses, the measured torque value increases, eventually reaching a maximum torque value. Designate the maximum or highest measured torque value as “MH”, expressed in dN-m. All other things being equal, the greater the MH torque value, the greater the extent of crosslinking. Determine the T90 crosslinking time as being the number of minutes required to achieve a torque value equal to 90% of the difference MH minus ML (MH-ML), i.e., 90% of the way from ML to MH. The shorter the T90 crosslinking time, i.e., the sooner the torque value gets 90% of the way from ML to MH, the faster the curing rate of the test sample. Conversely, the longer the T90 crosslinking time, i.e., the more time the torque value takes to get 90% of the way from ML to MH, the slower the curing rate of the test sample.

Water-Tree Growth Test Method was measured in accordance with ASTM D6097-01a, Standard Test Method for Relative Resistance to Vented Water-Tree Growth in Solid Dielectric Insulating Materials. This test method covers the relative resistance to water-tree growth in solid translucent thermoplastic or crosslinked electrical insulating materials. It is especially applicable to extruded polymeric insulation materials useful in medium-voltage power cables. Ten compression-molded disk specimens, each containing a controlled conical-shaped defect, are subjected to an applied voltage of 5 kilovolts (kV) at 1 kilohertz (kHz) and 23°±2° in an aqueous conductive solution of 0.01 Normal sodium chloride for 30 days. The controlled conical-shaped defect is created by a sharp needle with an included angle of 60° and a tip radius of 3 micrometers (μm). The electrical stress at the defect tip is thereby enhanced and is estimated by the Mason's Hyperbolic point-to-plane stress enhancement equation. This enhanced electrical stress initiates the formation of a vented water-tree grown from the defect tip. Each of the resulting treed specimens so produced is stained and sliced. The water-tree length and point-to-plane specimen thickness are measured under a microscope and used to calculate a ratio that is defined as the resistance to water-tree growth. Water-tree length (WTL) is the fraction of the thickness in the insulation material through which the water tree has grown. The lower the value of WTL, the better the water tree resistance. WTL is reported in percent (%).

### DETAILED DESCRIPTION

### 1. Crosslinkable Composition

The present disclosure provides a composition. In an embodiment, the composition is a crosslinkable composition and includes an ethylene-based polymer, an aminosilane, and optionally a peroxide. The aminosilane has the Formula (I)

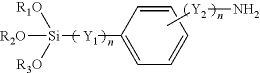

wherein
R₁, R₂, and R₃ are the same or different and each individually is selected from the group consisting of hydrogen and a C₁-C₂₀ alkyl group,

Y₁ is selected from the group consisting of an alkyl group and an alkoxy group,
Y₂ is selected from the group consisting of an alkyl group and an aminoalkyl group, and
n is 0 or 1.

The present disclosure provides a composition that is a crosslinkable composition. A “crosslinkable composition,” as used herein, is a composition containing an ethylene-based polymer and one or more additives (a free radical initiator or organic peroxide, for example) that enhance the ethylene-based polymer's ability to crosslink when subjected to crosslinking conditions (e.g., heat, irradiation, and/or UV light). After being subjected to the crosslinking conditions (e.g., “after crosslinking” or “after curing”), the crosslinkable composition becomes a “crosslinked composition” containing ethylene-based polymer that is crosslinked and is structurally and physically distinct to the crosslinkable composition.

The crosslinkable composition includes an ethylene-based polymer. Nonlimiting examples of suitable ethylene-based polymer include ethylene homopolymer, ethylene/α-olefin copolymer (linear or branched), high density polyethylene (“HDPE”), low density polyethylene (“LDPE”), linear low density polyethylene (“LLDPE”), medium density polyethylene (“MDPE”), and combinations thereof. The crosslinkable composition contains from 50 wt % to 99 wt %, or from 80 wt % to 99 wt %, or from 90 wt % to 99 wt %, or from 95 wt % to 99 wt % of the ethylene-based polymer, based on total weight of the crosslinkable composition.

In an embodiment, the ethylene-based polymer is an ethylene/C₃-C₂₀ α-olefin copolymer, or an ethylene/C₄-C₈ α-olefin copolymer having an α-olefin content from 1 wt % to 45 wt %, or from 5 wt % to 40 wt %, or from 10 wt % to 35 wt %, or from 15 wt % to 30 wt %, based on the total weight of the ethylene/C₃-C₂₀ α-olefin copolymer. Nonlimiting examples of C₃-C₂₀ α-olefin included propene, butene, 4-methyl-1-pentene, hexene, octene, decene, dodecene, tetradecene, hexadecene, and octadecene. The α-olefin can also have a cyclic structure such as 3 cyclohexyl-1-propene (allyl cyclohexane) and vinyl cyclohexane. Nonlimiting examples of suitable ethylene/C₃-C₂₀ α-olefin copolymer include ethylene/propylene copolymer, ethylene/butene copolymer, ethylene/hexene copolymer, and ethylene/octene copolymer.

In an embodiment, the ethylene-based polymer includes a non-conjugated diene comonomer. Suitable non-conjugated dienes include straight-chain, branched-chain or cyclic hydrocarbon dienes having from 6 to 15 carbon atoms. Examples of suitable non-conjugated dienes include, but are not limited to, straight-chain acyclic dienes, such as 1,4-hexadiene, 1,6-octadiene, 1,7-octadiene, and 1,9-decadiene; branched-chain acyclic dienes, such as 5-methyl-1,4-hexadiene, 3,7-dimethyl-1,6-octadiene, 3,7-dimethyl-1,7-octadiene, and mixed isomers of dihydromyricene and dihydroocinene; single-ring alicyclic dienes, such as 1,3-cyclopentadiene, 1,4-cyclohexadiene, 1,5-cyclooctadiene, and 1,5-cyclododecadiene; and multi-ring alicyclic fused and bridged-ring dienes, such as tetrahydroindene, methyl tetrahydroindene, dicyclopentadiene, and bicyclo-(2,2,1)-hepta-2,5-diene; alkenyl, alkylidene, cycloalkenyl, and cycloalkylidene norbornenes, such as 5-methylene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and norbornadiene.

In an embodiment, the ethylene-based polymer is an ethylene/propylene/diene terpolymer (or “EPDM”). Nonlimiting examples of suitable dienes include 1,4-hexadiene (“HD”), 5-ethylidene-2-norbornene (“ENB”), 5-vinylidene-2-norbornene (“VNB”), 5-methylene-2-norbornene (“MNB”), and dicyclopentadiene (“DCPD”). The diene content of the EPDM is from 0.1 wt % to 10.0 wt %, or from 0.2 wt % to 5.0 wt %, or from 0.3 wt % to 3.0 wt %, based on total weight of the EPDM.

In an embodiment, the ethylene-based polymer includes units derived from ethylene and units derived from at least one comonomer having the Structure (A):

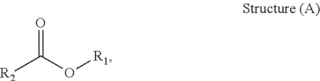

wherein R₁ is a C₁-C₄ hydrocarbonyl group, and
R₂ is a C₁-C₂ hydrocarbonyl group.

Nonlimiting examples of suitable R₁ groups include unsubstituted C₁-C₄ alkyl groups and unsubstituted C₂-C₄ alkenyl groups, including methyl groups, ethyl groups, propyl groups, butyl groups, ethenyl groups, propenyl groups, and butenyl groups. The unsubstituted C₁-C₄ alkyl groups and unsubstituted C₂-C₄ alkenyl groups may be branched or linear. In an embodiment, the R₁ group is an unsubstituted linear C₁-C₄ alkyl group or an unsubstituted C₂alkenyl group, including, for example, a methyl group, an ethyl group, a propyl group, a butyl group or an ethenyl group. In a further embodiment, the R₁ group is selected from a methyl group, an ethyl group, a butyl group and an ethenyl group. In an embodiment, the R₁ group is selected from a methyl group, an ethyl group, and a linear butyl group.

Nonlimiting examples of suitable R₂ groups include unsubstituted C₁-C₂ alkyl groups and unsubstituted C₂alkenyl groups, including methyl groups, ethyl groups, and ethenyl groups. In an embodiment, the R₂ group is selected from a methyl group and an unsubstituted ethene group.

In an embodiment, the ethylene-based polymer includes:
(i) one or more hydrolyzable silyl groups, hydrolyzable silyl group is independently a monovalent group of formula (R²)ₘ (R³)₃₋ₘ Si—, wherein subscript m is an integer of 1, 2, or 3; each R² is independently H, HO—, (C₁-C₆)alkoxy, (C₂-C₆)carboxy, phenoxy, (C₁-C₆)alkyl-phenoxy, ((C₁-C₆)alkyl) N—, (C₁-C₆)alkyl(H)C═NO—, or ((C₁-C₆)alkyl)₂C═NO—; and each R³ is independently (C₁-C 6)alkyl or phenyl;
(ii) a C₃-C₄₀ alpha-olefin comonomer; and
(iii) both (i) and (ii). Each R² may be free of H and HO—, alternatively free of phenoxy and (C1-C9)alkylphenoxy. Each R² may be independently (C₁-C₆)alkoxy, (C₂-C₆)carboxy, ((C₁-C₆)alkyl)₂N—, (C₁-C₉)alkyl(H)C═NO—, or ((C₁-C₉)alkyl)₂C═NO—; alternatively (C₁-C₉)alkoxy; alternatively (C₂-C₉)carboxy; alternatively ((C₁-C₉)alkyl)₂N—; alternatively (C₁-C₉)alkyl(H)C═NO—; alternatively ((C₁-C₉)alkyl)₂C═NO—.

In an embodiment, the ethylene-based polymer is a low density polyethylene (LDPE) homopolymer having one, some, or all of the following properties:
(i) a density from 0.91 to 0.93; and/or
(ii) a melt index from 0.5 g/10 min to 10.0 g 10 min, or from 1.0 g/10 min to 5.0 g/10 min.

The crosslinkable composition includes an aminosilane. The aminosilane has the structure of Formula (I)

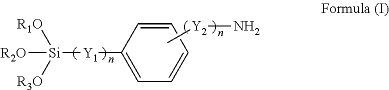

wherein
R₁, R₂, and R₃ are the same or different and each individually is selected from the group consisting of hydrogen and a C₁-C₂₀ alkyl group,
Y₁ is selected from the group consisting of an alkyl group and an alkoxy group,
Y₂ is selected from the group consisting of an alkyl group and an aminoalkyl group, and
n is 0 or 1. The crosslinkable composition includes from 0.1 wt % to 1.0 wt %, or from 0.1 wt % to 0.9 wt %, or from 0.2 wt % to 0.8 wt %, or from 0.3 wt % to 0.7 wt % of the aminosilane; weight percent is based on total weight of the crosslinked composition.

R₁, R₂, and R₃ are the same or different and each individually is selected from the group consisting of hydrogen and a C₁-C₂₀ alkyl group. In an embodiment, R₁, R₂, and R₃ are the same and each is selected from a C₁-C₄ alkyl group, such as methyl group, ethyl group, propyl group, and butyl group. In an further embodiment, R₁, R₂, and R₃ are the same and each is a methyl group.

In an embodiment, the crosslinkable composition includes an aminosilane having the Formula (I)

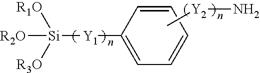

wherein
R₁, R₂, and R₃ are the same or different and each individually is selected from the group consisting of hydrogen and a C₁-C₄ alkyl group,
Y₁ is a C₁-C₄ alkyl group,
Y₂ is selected from the group consisting of an alkyl group and an aminoalkyl group, and
n is 1.

In an embodiment, the crosslinkable composition includes an aminosilane having the Formula (I)

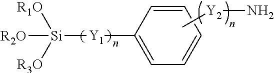

wherein
R₁, R₂, and R₃ are the same or different and each individually is selected from the group consisting of hydrogen and a C₁-C₄ alkyl group,
Y₁ is a C₁-C₄ alkoxy group,
Y₂ is selected from the group consisting of an alkyl group and an aminoalkyl group, and
n is 1.

In an embodiment, the crosslinkable composition includes an aminosilane having the Formula (I)

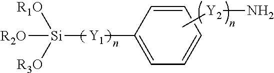

wherein
R₁, R₂, and R₃ are the same or different and each individually is selected from the group consisting of hydrogen and a C₁-C₄ alkyl group, and
n is 0.

Nonlimiting examples of suitable aminosilane of Formula (I) include 3-aminophenyltrimethoxysilane, p-aminophenyltrimethoxysilane, (aminoethylaminomethyl)phenethyltrimethoxysilane, 3-(m- aminophenoxy)propyltrimethoxysilane, and combinations thereof.

In an embodiment, the aminosilane of Formula (I) is 3-aminophenyltrimethoxysilane, p-aminophenyltrimethoxysilane, and combinations thereof.

In an embodiment, the aminosilane of Formula (I) is p-aminophenyltrimethoxysilane.

In addition to the ethylene-based polymer and the aminosilane of Formula (I), the present crosslinkable composition optionally includes a free radical initiator. In an embodiment, the free radical initiator is present in the crosslinkable composition and the free radical initiator is an organic peroxide. The organic peroxide is a molecule containing carbon atoms, hydrogen atoms, and two or more oxygen atoms, and having at least one —O—O-group, with the proviso that when more than one —O—O-group is present, each —O—O-group is bonded indirectly to another —O—O-group via one or more carbon atoms, or collection of such molecules. Nonlimiting examples of suitable organic peroxide include diacylperoxides, peroxycarbonates, peroxydicarbonates, peroxyesters, peroxyketals, cyclic ketone peroxides, dialkylperoxides, ketone peroxides, and combinations thereof. When the organic peroxide is present, the crosslinkable composition includes from greater than 0 wt % to less than 2 wt %, or from 0.1 wt % to 1.9 wt %, or from 0.2 to 1.8 wt % of the peroxide, based on total weight of the crosslinkable composition. It is understood that the aggregate of ethylene-based polymer, aminosilane of Formula (I), and peroxide amount to 100 wt % of the crosslinkable composition.

The organic peroxide may be a monoperoxide of formula R^{O}-O—O-R^{O}, wherein each R^{O} independently is a (C₁-C₂₀) alkyl group or (C₆-C₂₀) aryl group. Each (C₁-C₂₀) alkyl group independently is unsubstituted or substituted with 1 or 2 (C₆-C₁₂) aryl groups. Each (C₆-C₂₀) aryl group is unsubstituted or substituted with 1 to 4 (C₁-C₁₀) alkyl groups. Alternatively, the organic peroxide may be a diperoxide of formula R^{O}-O—O-R-O—O-R^{O}, wherein R is a divalent hydrocarbon group such as a (C₂-C₁₀) alkylene, (C₃-C₁₀) cycloalkylene, or phenylene, and each R^{O} is as defined above.

Nonlimiting examples of suitable organic peroxides include dicumyl peroxide (DCP); lauryl peroxide; benzoyl peroxide; tertiary butyl perbenzoate; di (tertiary-butyl) peroxide; cumene hydroperoxide; 2, 5-dimethyl-2, 5-di (t-butyl-peroxy) hexyne-3; 2,-5-di-methyl-2, 5-di (t-butyl-peroxy) hexane; tertiary butyl hydroperoxide; isopropyl percarbonate; alpha, alpha′-bis (tertiary-butylperoxy) diisopropylbenzene; t-butylperoxy-2-ethylhexyl-monocarbonate; 1,1-bis (t-butylperoxy) -3,5,5-trimethyl cyclohexane; 2,5-dimethyl-2,5-dihydroxyperoxide; t-butylcumylperoxide; alpha, alpha′-bis (t-butylperoxy)-p-diisopropyl benzene; bis (1,1-dimethylethyl) peroxide; bis (1,1-dimethylpropyl) peroxide; 2,5-dimethyl-2,5-bis (1,1-dimethylethylperoxy) hexane; 2,5-dimethyl-2,5-bis (1,1-dimethylethylperoxy) hexyne; 4,4-bis (1,1-dimethylethylperoxy) valeric acid; butyl ester; 1,1-bis (1,1-dimethylethylperoxy)-3,3,5-trimethylcyclohexane; benzoyl peroxide; tert-butyl peroxybenzoate; di-tert-amyl peroxide (“DTAP”); bis (alpha-t-butyl-peroxyisopropyl) benzene (“BIPB”); isopropylcumyl t-butyl peroxide; t-butylcumylperoxide; di-t-butyl peroxide; 2,5-bis (t-butylperoxy)-2,5-dimethylhexane; 2,5-bis (t-butylperoxy)-2,5-dimethylhexyne-3,1,1-bis (t-butylperoxy)-3,3,5-trimethylcyclohexane; isopropylcumyl cumylperoxide; butyl 4,4-di (tert-butylperoxy) valerate; di (isopropylcumyl) peroxide; and the like.

In an embodiment, the free radical initiator is present in the crosslinkable composition and the free radical initiator is an organic peroxide that is dicumyl peroxide (DCP).

The present crosslinkable composition may include one or more optional additives. When the additive is present, non-limiting examples of suitable additives include antioxidant, a scorch retardant, a coagent (such as triallyl iso-cyanurate, triallyl trimellitate, triallyl cyanurate, trimethylolpropane triacrylate, trimethylolpropane trimethylacrylate, ethoxylated bisphenol A dimethacrylate, 1,6-hexanediol diacrylate, pentaerythritol tetraacrylate, dipentaerythritol pentaacrylate, N,N,N′,N′,N″,N″-hexaallyl-1,3,5-triazine-2,4,6-triamine, tris(2-hydroxyethyl) isocyanurate triacrylate, propoxylated glyceryl triacrylate, 2,4-diphenyl-4-methyl-1-pentene, 1,3-diisopropenylbenzene, tetra methyltetravinylcyclotetrasiloxane, trivinyltrimethylcyclotrisiloxane, pentavinylpentamethylcyclopentasiloxane), a nucleating agent, a processing aid, an extender oil, carbon black, nanoparticles, a UV stabilizer, and combinations thereof.

In an embodiment, the crosslinkable composition includes one or more antioxidants. Nonlimiting examples of suitable antioxidants include bis(4-(1-methyl-1-phenylethyl)phenyl)amine (e.g., NAUGARD 445); 2,2-methylene-bis(4-methyl-6-t-butylphenol) (e.g., VANOX MBPC); 2,2′-thiobis(2-t-butyl-5-methylphenol (CAS No. 90-66-4), CAS No. 96-69-5, commercially LOWINOX TBM-6);2,2′-thiobis(6-t-butyl-4-methylphenol (CAS No. 90-66-4, commercially LOWINOX TBP-6); tris[(4-tert-butyl-3-hydroxy-dimethylphenyl)methyl]-1,3,5-triazine-2,4,6-trione (e.g., CYANOX 1790); pentaerythritol tetra kis(3-(3,5-bis(1,1-dimethylethyl)-4-hydroxyphenyl)propionate (e.g., IRGANOX 1010, CAS Number 6683-19-8); 3,5-bis(1,1-dimethylethyl)-4-hydroxybenzenepropanoic acid 2,2′-thiodiethanediyl ester (e.g., IRGANOX 1035, CAS Number 41484-35-9); distearylthiodipropionate (“DSTDP”); dilaurylthiodipropionate (e.g., IRGANOX PS 800); stearyl 3-(3,5-di-t-butyl-4-hydroxyphenyl)propionate (e.g., IRGANOX 1076); 2,4-bis(dodecylthiomethyl)-6-methylphenol (IRGANOX 1726); 4,6-bis(octylthiomethyl)-o-cresol (e.g. IRGANOX 1520); and 2′,3-bis[[3-[3,5-di-tert-butyl-4-hydroxyphenyl]propionyl]] propionohydrazide (IRGANOX 1024); 4,4-thiobis(2-t-butyl-5-methylphenol) (also known as 4,4′-thiobis(6-tert-butyl-m-cresol); 2,2′-thiobis(6-t-butyl-4-methylphenol; tris[(4-tert-butyl-3-hydroxy-2,6-dimethylphenyl)methyl]-1,3,5-triazine-2,4,6-trione; distearylthiodipropionate; Cyanox 1790 (CAS: 40601-76-1); Uvinul 4050 (CAS: 124172-53-8); and combinations thereof. The antioxidant is present from 0.01 wt % to 1.5 wt %, or from 0.05 wt % to 1.2 wt %, or from 0.07 wt % to 1.0 wt %, or from 0.1 wt % to 0.5 wt %, based on the total weight of the crosslinkable composition.

In an embodiment, the crosslinkable composition includes
from 80 wt % to 99 wt %, or from 90 wt % to 99 wt %, or from 95 wt % to 99 wt % of the ethylene-based polymer;
from 0.1 wt % to 1.0 wt %, or from 0.1 wt % to 0.9 wt %, or from 0.2 wt % to 0.8 wt %, or from 0.3 wt % to 0.7 wt % wt % of the aminosilane ; and
from greater than 0 wt % to less than 2 wt %, or from 0.5 wt % to 1.9 wt % peroxide, wherein weight percent is based on total weight of the crosslinkable composition. It is understood that the aggregate of the ethylene-based polymer, the aminosilane, and the peroxide amount to 100 wt % of the crosslinkable composition.

The components of the crosslinkable composition are processed and mixed to cure the crosslinkable composition and form a crosslinked composition. Pellets of the ethylene-based polymer are fed into a mixing device (such as a Brabender mixer, for example) at a temperature from 120° C. to 180° C. to melt the ethylene-based polymer. The aminosilane (and any optional additives, such as antioxidant) are fed into the mixing device and melt-mixed into the ethylene-based polymer. The mixed compound composed of ethylene-based polymer and aminosilane (and optional additive) (hereafter the “AS-PE compound”) is collected, and cut into small pieces.

Mixing of the AS-PE compound and the free radical initiator occurs by placing pieces of the AS-PE compound and peroxide (and optionally antioxidant(s)) into a container. The container is subsequently shaken, rotated, tumbled, or otherwise agitated so that the peroxide contacts and is retained by, or otherwise the peroxide is absorbed into, the pieces of the AS-PE compound. The process includes heating the mixture of the AS-PE compound and the peroxide at a temperature from 60° C., or 70° C., or 80° C. to 90° C., or 100° C. or otherwise heating at a temperature greater than the melting temperature of peroxide. Heating of the mixture occurs for a duration from 1 minute, or 10 minutes, or 30 minutes to 1 hour, or 2 hours, or 3 hours, or 4 hours, or 5 hours, or 6 hours, or 7 hours, or 8 hours, thereby enabling the peroxide to diffuse into the AS-PE compound pellets.

In an embodiment, the mixing and the heating occur sequentially.

In an embodiment, the mixing and the heating occur simultaneously.

The peroxide-containing AS-PE pieces are cured (i.e., “crosslinked”) by heating at a curing temperature from greater than 100° C., or 110° C., or 125° C. to 150° C., or 180° C., or 200° C. for a duration from 1 minute, or 5 minutes, or 10 minutes, or 30 minutes, or 1 hour to 2 hours, or 5 hours, or 7 hours, or more to form a crosslinked composition composed of the ethylene-based polymer, the aminosilane, and optional additives. The crosslinked composition is structurally and physically distinct to the crosslinkable composition.

### 2. Crosslinked Composition

In an embodiment, a crosslinked composition is provided. The crosslinked composition includes an ethylene-based polymer, an aminosilane, and optional additives. The aminosilane has the Formula (I)

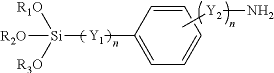

wherein
R₁, R₂, and R₃ are the same or different and each individually is selected from the group consisting of hydrogen and a C₁-C₂₀ alkyl group,
Y₁ is selected from the group consisting of an alkyl group and an alkoxy group,
Y₂ is selected from the group consisting of an alkyl group and an aminoalkyl group, and
n is 0 or 1.

The ethylene-based polymer in the crosslinked composition can be any ethylene-based polymer in the crosslinkable composition as previously disclosed herein. In an embodiment, the ethylene-based polymer of the crosslinked composition is an LDPE ethylene homopolymer having has a density from 0.91 g/cc to 0.93 g/cc, and a melt index from 0.5 g/10 min to 5.0 g/10 min.

In an embodiment, the crosslinked composition includes
from 90 wt % to 99.9 wt %, or from 90 wt % to 99 wt %, or from 95 wt % to 99 wt % of the ethylene-based polymer;
from 0.1 wt % to 1.0 wt %, or from 0.1 wt % to 0.9 wt %, or from 0.2 wt % to 0.8 wt %, or from 0.3 wt % to 0.7 wt % of the aminosilane of Formula (I), wherein weight percent is based on total weight of the crosslinked composition

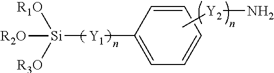

wherein
R₁, R₂, and R₃ are the same or different and each individually is selected from the group consisting of hydrogen and a C₁-C₂₀ alkyl group,
Y₁ is selected from the group consisting of an alkyl group and an alkoxy group,
Y₂ is selected from the group consisting of an alkyl group and an aminoalkyl group,
   n is 0 or 1, and
   the crosslinked composition has
   (i) an average WTL less than 10%, or from 1% to less than 8%, and
   (ii) a dissipation factor (DF) less than 0.1%, or from 0.01% to 0.09%. It is understood that the aggregate of the ethylene-based polymer and the aminosilane of Formula (I), and optional additives amount to 100 wt % of the crosslinked composition.

In an embodiment, the crosslinked composition includes
from 90 wt % to 99.9 wt %, or from 90 wt % to 99 wt %, or from 95 wt % to 99 wt % of the ethylene-based polymer;
from 0.1 wt % to 1.0 wt %, or from 0.1 wt % to 0.9 wt %, or from 0.2 wt % to 0.8 wt %, or from 0.3 wt % to 0.7 wt % of the aminosilane of Formula (I) (wherein weight percent is based on total weight of the crosslinked composition)

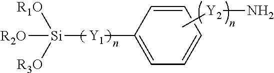

wherein
R₁, R₂, and R₃ are the same or different and each individually is selected from the group consisting of hydrogen and a C₁-C₄ alkyl group,
Y₁ is a C₁-C₄ alkyl group,
Y₂ is selected from the group consisting of an alkyl group and an aminoalkyl group, and
n is 1 and
the crosslinked composition has
(i) an average WTL less than 10%, or from 1% to less than 8%, and
(ii) a dissipation factor (DF) less than 0.1%, or from 0.01% to 0.09%. It is understood that the aggregate of the ethylene-based polymer and the aminosilane of Formula (I), and optional additives amount to 100 wt % of the crosslinked composition.

In an embodiment, the crosslinked composition includes
from 90 wt % to 99.9 wt %, or from 90 wt % to 99 wt %, or from 95 wt % to 99 wt % of the ethylene-based polymer;
from 0.1 wt % to 1.0 wt %, or from 0.1 wt % to 0.9 wt %, or from 0.2 wt % to 0.8 wt %, or from 0.3 wt % to 0.7 wt % of the aminosilane of Formula (I) (wherein weight percent is based on total weight of the crosslinked composition)

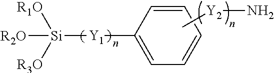

wherein
R₁, R₂, and R₃ are the same or different and each individually is selected from the group consisting of hydrogen and a C₁-C₄ alkyl group,
Y₁ is a C₁-C₄ alkoxy group,
Y₂ is selected from the group consisting of an alkyl group and an aminoalkyl group, and
n is 1, and
the crosslinked composition has
(i) an average WTL less than 10%, or from 1% to less than 8%, and
(ii) a dissipation factor (DF) less than 0.1%, or from 0.01% to 0.09%. It is understood that the aggregate of the ethylene-based polymer and the aminosilane of Formula (I), and optional additives amount to 100 wt % of the crosslinked composition.

In an embodiment, the crosslinked composition includes
from 90 wt % to 99.9 wt %, or from 90 wt % to 99 wt %, or from 95 wt % to 99 wt % of the ethylene-based polymer;
from 0.1 wt % to 1.0 wt %, or from 0.1 wt % to 0.9 wt %, or from 0.2 wt % to 0.8 wt %, or from 0.3 wt % to 0.7 wt % of the aminosilane of Formula (I) (wherein weight percent is based on total weight of the crosslinked composition)

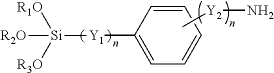

wherein
R₁, R₂, and R₃ are the same or different and each individually is selected from the group consisting of hydrogen and a C₁-C₄ alkyl group,
   n is 0, and
   the crosslinked composition has
   (i) an average WTL less than 10%, or from 1% to less than 8%, and
   (ii) a dissipation factor (DF) less than 0.1%, or from 0.01% to 0.09%. In a further embodiment, the aminosilane is p-aminophenyltrimethoxysilane. It is understood that the aggregate of the ethylene-based polymer and the aminosilane of Formula (I), and optional additives amount to 100 wt % of the crosslinked composition.

The present crosslinked composition may include one or more optional additives. When the additive is present in the crosslinked composition, the additive can be any additive as in the crosslinkable composition as previously disclosed herein.

Applications

The crosslinked composition may be employed in a variety of applications including, but not limited to, wire and cable applications, such as an insulation layer for MV/HV/EHV cable for AC (alternating current) and DC (direct current), a semi-conductive layer filled with carbon black for MV/HV/EHV cable, an accessory for a power distribution transmission line, an insulation layer, an insulation encapsulation film for a photovoltaic (PV) module.

By way of example, and not limitation, some embodiments of the present disclosure will now be described in detail in the following examples.

### EXAMPLES

Materials used in the examples are set forth in Table 1 below.

TABLE 1

| Component | Structure | Supplier |
|---|---|---|
| DCP Dicumyl peroxide (CAS: 80-43-3) | 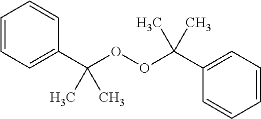 [SMILES: CC(C)(OOC(C)(C)c1ccccc1)c1ccccc1] | Fangruida |
| LDPE1 | Ethylene homopolymer | Dow |
| (density: 0.92 g/cc; melt index: 2.0 g/10 | | |
| min) | | |
| p-APTMS aminophenyltrimethoxysilane (CAS: 33976-43-1 ) | 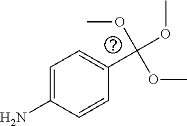 | Gelest |
| TBM-6 4,4′-Thiobis(6-tert-butyl-m-cresol) (CAS: 96-69-5) | 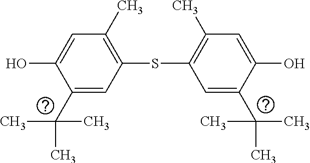 [SMILES: Cc1cc(O)c(C(C)(C)C)cc1Sc1cc(C(C)(C)C)c(O)cc1C] | TCl |
| Aniline (CAS: 62-53-3) | 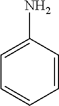 | TCl |
| PTMS Trimethoxyphenylsilane (CAS: 2996-92-1) | 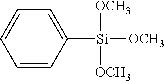 [SMILES: CO[Si](OC)(OC)c1ccccc1] | TCl |
| MATMS Trimethoxy[3- (methylamino)propyl]silane (CAS: 3069-25-8) | 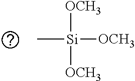 | TCl |
| PAMTES N-phenylaminomethyltriethoxysilane (CAS: 3473-76-5) | 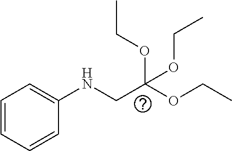 [SMILES: CCOC(CNc1ccccc1)(OCC)OCC] | Gelest |
| PEG 20000 Polyethyleneglycol (CAS: 25322-68-3) | 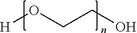 | Clariant |
| DEATMS [3-(Diethylamino)propyl]trimethoxysilane (CAS: 41051-80-3) | 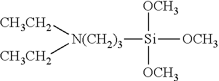 | TCl |
| AEAPTMS 3-(2- Aminoethylamino)propyltrimethoxysilane (CAS: 1760-24-3) | 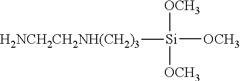 | TCl |

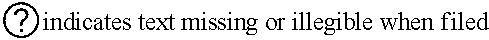

### 1. Compounding

LDPE1 pellets were fed into the Brabender mixer at set temperature of 160° C. with a rotor speed of 10 rpm. Antioxidant (TBM-6) and component(s) from Table 1 were fed into the polymer melt at the set temperature to form individual samples with different component(s) from Table 1. Final mixing was operated at the set temperature and a rotor speed of 45 rpm for 4 minutes. The compound was collected, and cut into small pieces for use.

### 2. Pelletizing

The compound samples were fed into the hopper of Brabender single screw extruder. The compound samples were extruded to melt strand at 120° C. with a screw speed of 25 rpm. The melt strand was fed into a Brabender Pelletizer to prepare the pellets.

### 3. Soaking

A 250 mL fluorinated HDPE bottle was applied to seal 50 g pellets and 0.865 g DCP. The bottle was sealed tightly. Soaking was conducted at 70° C. for 8 hours. The bottle was shaken every 0, 2, 5, 10, 20, 30 minutes in the soaking process. The pellets soaked with DCP (XLPE pellets) were stored in the fluorinated bottle for test after soaking process.

### 4. Hot Press Curing of XLPE Plaque

The mold size/plaque sample size was 180×190×0.5 mm. 15 g XLPE pellets were weighed and sandwiched between two 2 mm PET films. The pellets and PET films were put into the mold. The mold was sandwiched between the upper and lower plates of hot press machine and mold for 10 minutes at 120° C. and 0 MPa for preheating. The temperature was heated up from 120° C. to 180° C. within 7 minutes at 10 MPa for curing. The mold was held at 120° C. and 5 MPa 0.5 minutes. The mold was held at 120° C. and 10 MPa for 0.5 minutes. After venting for 8 times, the mold was held for 13 minutes at 180° C. and 10 MPa for curing. The mold was cooled from 180° C. to 60° C. within 10 minutes at 10 MPa. The XLPE plaque was removed from the mold. Table 2 below provides the composition and properties for each individual sample.

TABLE 2
Performance Evaluation Results

| Component | CS 1 | CS 2 | CS 3 | CS 4 | CS 5 | CS 6 | CS 7 | CS 8 | IE 1 | IE 2 |
|---|---|---|---|---|---|---|---|---|---|---|
| Intermediate (0.08 | 98.30 | 98.19 | 98.07 | 98.07 | 97.98 | 98.02 | 98.04 | 97.70 | 98.05 | 97.70 |
| wt. % TBM-6 in | | | | | | | | | | |
| LDPE1) (wt. %) | | | | | | | | | | |
| DCP (wt. %) | 1.70 | 1.70 | 1.70 | 1.70 | 1.70 | 1.70 | 1.70 | 1.70 | 1.70 | 1.70 |
| Aniline (wt. %) | — | 0.11 | — | — | — | — | — | — | — | — |
| PTMS (wt. %) | — | — | 0.23 | — | — | — | — | — | — | — |
| MATMS (wt. %) | — | — | — | 0.23 | — | — | — | — | — | — |
| PAMTES (wt. %) | — | — | — | — | 0.32 | — | — | — | — | — |
| DEATMS (wt. %) | — | — | — | — | — | 0.28 | — | — | — | — |
| AEAPTMS (wt. %) | — | — | — | — | — | — | 0.26 | — | — | — |
| PEG 20000 (wt. %) | — | — | — | — | — | — | — | 0.60 | — | — |
| p-APTMS (wt. %) | — | — | — | — | — | — | — | — | 0.25 | 0.60 |
| Results | CS 1 | CS 2 | CS 3 | CS 4 | CS 5 | CS 6 | CS 7 | CS 8 | IE 1 | IE 2 |
| Average WTL (%) | 28.08 | 35.53 | 34.03 | 12.58 | 14.30 | 19.08 | 12.73 | 6.82 | 5.03 | 7.14 |
| DF @ 25 kV/mm, | 0.03 | 0.03 | 0.06 | 0.10 | 0.04 | 0.15 | 0.11 | 1.32 | 0.07 | 0.09 |
| 95° C./50 Hz (%) | | | | | | | | | | |
| ML/180° C. (dNm) | 0.22 | 0.22 | 0.21 | 0.24 | 0.23 | 0.23 | 0.23 | 0.19 | 0.22 | 0.23 |
| MH/180º C. (dNm) | 4.77 | 4.31 | 4.76 | 4.61 | 4.22 | 4.21 | 4.49 | 3.51 | 4.43 | 3.98 |
| MH-ML/180° C. | 4.55 | 4.09 | 4.55 | 4.37 | 3.99 | 3.98 | 4.26 | 3.32 | 4.21 | 3.75 |
| (dNm) | | | | | | | | | | |
| ts1/180° C. (min) | 1.00 | 1.03 | 0.97 | 0.96 | 1.06 | 1.03 | 1.00 | 1.27 | 1.01 | 1.02 |
| t90/180° C. (min) | 4.48 | 4.36 | 4.78 | 4.22 | 4.29 | 4.12 | 4.27 | 4.65 | 4.26 | 4.25 |

CS = comparative sample; IE = inventive example

Table 2 shows IE1-2 have a combination of (i) low water tree length (WTL) of less than 10% (5.0% and 7.2%) and (ii) low DF of less than 0.1% (0.07% and 0.09%). In contrast, no comparative sample can achieve low WTL of less than 10% and low DF of less than 0.1%. The ability of the present crosslinkable composition with aminosilane of Formula (I) to obtain a crosslinked composition with low WTL and low DF while not deleteriously impacting crosslinking is unexpected.

It is specifically intended that the present disclosure not be limited to the embodiments and illustrations contained herein, but include modified forms of those embodiments including portions of the embodiments and combinations of elements of different embodiments as come within the scope of the following claims.

1. A crosslinkable composition comprising:
an ethylene-based polymer;
an aminosilane having the Formula (I) 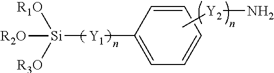
wherein
R₁, R₂, and R₃ are the same or different and each individually is selected from the group consisting of hydrogen and a C₁-C₂₀ alkyl group,
Y₁ is selected from the group consisting of an alkyl group and an alkoxy group,
Y₂ is selected from the group consisting of an alkyl group and an aminoalkyl group,
n is 0 or 1; and
optionally a peroxide.

2. The crosslinkable composition of claim 1 wherein the ethylene-based polymer has a density from 0.91 g/cc to 0.93 g/cc; and
a melt index from 0.5 g/10 min to 5.0 g/10 min.

3. The crosslinkable composition of claim 1 comprising the aminosilane having the Formula (I) 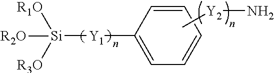
wherein
R₁, R₂, and R₃ are the same or different and each individually is selected from the group consisting of hydrogen and a C₁-C₄ alkyl group,
Y₁ is a C₁-C₄ alkyl group,
Y₂ is selected from the group consisting of an alkyl group and an aminoalkyl group, and
n is 1.

4. The crosslinkable composition of claim 1 comprising the aminosilane having the Formula (I) 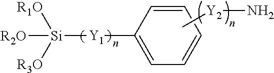
wherein
R₁, R₂, and R₃ are the same or different and each individually is selected from the group consisting of hydrogen and a C₁-C₄ alkyl group,
Y₁ is a C₁-C₄ alkoxy group,
Y₂ is selected from the group consisting of an alkyl group and an aminoalkyl group, and
n is 1.

5. The crosslinkable composition of claim 1 comprising the aminosilane having the Formula (I) 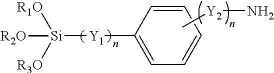
wherein
R₁, R₂, and R₃ are the same or different and each individually is selected from the group consisting of hydrogen and a C₁-C₄ alkyl group, and
n is 0.

6. The crosslinkable composition of claim 1 comprising
from 80 wt % to 99 wt % of the ethylene-based polymer;
from 0.1 wt % to 0.9 wt % of the aminosilane; and
from greater than 0 wt % to less than 2 wt % peroxide.

7. The crosslinkable composition of claim 1 comprising an additive selected from the group consisting of an antioxidant, a scorch retardant, a coagent, a nucleating agent, a processing aid, an extender oil, carbon black, nanoparticles, a UV stabilizer, and combinations thereof.

8. A crosslinked composition comprising:
an ethylene-based polymer;
an aminosilane having the Formula (I) 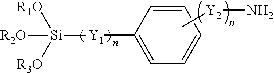
wherein
R₁, R₂, and R₃ are the same or different and each individually is selected from the group consisting of hydrogen and a C₁-C₂₀ alkyl group,
Y₁ is selected from the group consisting of an alkyl group and an alkoxy group,
Y₂ is selected from the group consisting of an alkyl group and an aminoalkyl group,
n is 0 or 1.

9. The crosslinked composition of claim 8 wherein the ethylene-based polymer has a density from 0.91 g/cc to 0.93 g/cc; and
a melt index from 0.5 g/10 min to 5.0 g/10 min.

10. The crosslinked composition of claim 8 comprising the aminosilane having the Formula (I) 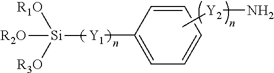
wherein
R₁, R₂, and R₃ are the same or different and each individually is selected from the group consisting of hydrogen and a C₁-C₄ alkyl group,
Y₁ is a C₁-C₄ alkyl group,
Y₂ is selected from the group consisting of an alkyl group and an aminoalkyl group, and
n is 1.

11. The crosslinked composition of claim 8 comprising the aminosilane having the Formula (I) 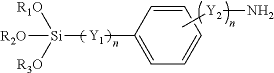
wherein
R₁, R₂, and R₃ are the same or different and each individually is selected from the group consisting of hydrogen and a C₁-C₄ alkyl group,
Y₁ is a C₁-C₄ alkoxy group,
Y₂ is selected from the group consisting of an alkyl group and an aminoalkyl group, and
n is 1.

12. The crosslinked composition of claim 8 comprising the aminosilane having the Formula (I) 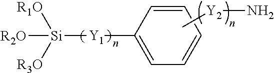
wherein
R₁, R₂, and R₃ are the same or different and each individually is selected from the group consisting of hydrogen and a C₁-C₄ alkyl group, and
n is 0.

13. The crosslinked composition of claim 8 comprising an additive selected from the group consisting of an antioxidant, a scorch retardant, a coagent, a nucleating agent, a processing aid, an extender oil, carbon black, nanoparticles, a UV stabilizer, and combinations thereof.

14. The crosslinked composition of claim 8 comprising
from 90 wt % to 99 wt % of the ethylene-based polymer;
from 0.1 wt % to 1.0 wt % of the aminosilane; and
the crosslinked composition has
(i) an average WTL less than 10.0%, and
(ii) a dissipation factor less than 0.1%.
